(19) United States
(12) Patent Application Publication
(10) Pub. No.: US 2002/0122134 A1
(43) Pub. Date: Sep. 5, 2002

(54) Video display array of sealed, modular units

(76) Inventor: Kevin A. Kalua, Angwin, CA (US)

Correspondence Address: Harris Zimmerman, Law Offices of Harris Zimmerman, Suite 710, 1330 Broadway, Oakland, CA, 94612-2506, US

(21) Appl. No.: 09/798,391

(22) Filed: Mar. 5, 2001

(51) Int. Cl. H04N 5/66; H04N 9/12; H04N 5/64

(52) U.S. Cl. 348/383; 348/836

(57) ABSTRACT

A large format modular video display includes a plurality of video image units, each image unit sealed against environmental intrusions. Each image unit includes a housing having a front panel and a rear door panel that may be opened for access to the interior. Within the housing, a strongback member supports an LED circuit board having a large plurality of LEDs supported in pixel array, each pixel comprised of a plurality of LEDs of various colors. A gasket member is dimensioned to cover the pixel array of LEDs, and includes an array of LED holes in registration with the pixel array of the LED board, so that each LED extends through a respective hole in the gasket. The front panel of the housing also includes an array of LED holes in registration with the holes of the gasket member, so that each pixel group of LEDs may extend through respective holes in the front panel and protrude forwardly therefrom. The LED circuit board and front panel are joined in compressive fashion with the gasket member sandwiched therebetween to seal the LED holes of the front panel and prevent intrusion of weather. A sunshade secured to the front panel includes a shade panel having an array of pixel holes, so that each pixel group of LEDs may protrude through a respective pixel hole in the sunshade. The sunshade includes a plurality of shade flanges, each shade flange disposed directly above a respective row of pixel holes in the shade panel.

### BACKGROUND OF THE INVENTION

The present invention relates to large format video displays (video walls), and, more particularly, to large format displays employing light emitting semiconductor devices in large arrays.

The development and improvement of light emitting diodes (LEDs), which has resulted in bright light sources having colors throughout the visible spectrum. very long life, and reasonable prices, has driven the revolution in large format video displays from CRT-based systems to LED-based systems. LED video systems have brighter output, wider viewing angle, and far greater energy efficiency.

Although LEDs have an extremely long mean time before failure (MTBF), they must be protected from damage due to particular operating conditions. For example, when LEDs overheat the life expectancy quickly may be shortened by factors of 10. Heat buildup may be caused not only by the waste heat of the LEDs operating at high power, but also by external factors such as hot ambient air due to hot weather, high heat loads from direct sunlight, and the like. Generally speaking, some form of cooling system must be available to rid the LED systems of heat buildup to avoid diminishing the life of the LEDs.

Furthermore, many large format video systems are installed outdoors, in stadiums, along highways, and the like. In this environment they are subjected to extremes of temperature, infiltration by water, damage from freezing water, insects, and the like. To overcome this problem, systems known in the prior art have resorted to joining the assembly of an LED circuit board and other structural components with potting compound, thereby creating a solid unit that is impervious to water and the damaging effects of ice. In addition, the same potting compound is often used to retain a sunshade component to the outer surface of the LED display.

Unfortunately, the potting compound forms a permanent unit that cannot be disassembled for service. Thus, for example, if one pixel of a display is damaged or fails spontaneously, it is not possible to disassemble and remove and replace the LED circuit board in the video display. Nor is it possible to salvage the shade component for further use, or other portions of the video display assembly. In this example, the entire unit must be junked.

There is a need in the prior art for a video display system that is sealed and weatherproof to avoid damage from environmental factors, yet may be dismantled for repair and replacement of component parts.

### SUMMARY OF THE INVENTION

The present invention generally comprises a large format video display that is highly modular in construction and adaptable to a variety of uses and installations. The modular arrangement includes a plurality of video image units, and each image unit is sealed against weather and other environmental intrusions, yet may be disassembled for repair and replacement of damaged components.

In one aspect of the invention, each image unit is comprised of a rectangular housing having a front panel and a rear door panel that may be opened for access to the interior of the housing. Within the housing, a strongback member extends generally parallel to the front panel, and includes mounting holes for a driver circuit board at the rear surface thereof. Joined to the front surface of the strongback member is an LED circuit board, on which a large plurality of LEDs are supported and connected to traces that are in turn connected to the driver board. The LEDs are grouped in pixel array, each pixel comprised of LEDs of various colors and combined to emit light across the visible spectrum.

The image unit assembly further includes a gasket member comprised of a sheet of flexible, impervious material. The gasket member is sufficiently wide and long to cover the pixel array of LEDs. An array of pixel holes in the gasket member is formed to be in registration with the pixel array of the LED board, so that each pixel group of LEDs extends through a respective pixel hole in the gasket. The front panel of the housing also includes an array of pixel holes in registration with the pixel holes of the gasket member, so that each pixel group of LEDs may extend through a respective pixel hole in the front panel and protrude forwardly therefrom. The LED circuit board and front panel are joined by a threaded fastener system in compressive fashion with the gasket member therebetween to seal the pixel holes of the front panel and prevent intrusion of weather. Thus the system is sealed, yet is disassemblable for service and repair.

In a further aspect of the invention, each image unit assembly is provided with a sunshade removably secured to the front panel of the unit. The sunshade includes a shade panel having another array of pixel holes in registration with the pixel holes of the front panel and the gasket member, so that each pixel group of LEDs may protrude through the sunshade. The sunshade further includes a plurality of shade flanges, each shade flange extending laterally and disposed directly above a respective row of pixel holes in the shade panel. Each shade flange extends outwardly and forwardly from the surface of the shade panel to block at least partially the bright light emanating from the sun and sky from impinging on the protruding output ends of the LEDs. The shade panel and shade flanges may be provided with a dark absorptive coating, such a black anodized aluminum, to minimize reflection of light from bright sources, and to maximize the effect of the LEDs outputs.

In another aspect, the invention includes a particular pixel grouping that is designed to minimize the effects of bright light impinging on the each pixel group. Each pixel group is formed of five LEDs disposed in parallel rows of three and two LEDs. The top row is formed of red, blue, and green LEDs, and is directly under the respective shade flange of the pixel. The bottom row is formed of red and green LEDs centered at the interstitial spacing of the top row. The top row is in the deepest shade of the respective shade flange, and sunlight from high angles may shine on the bottom row but will not impinge on the top row of LEDs. Since the top row includes the blue LED as well as the red and green, sunlight shining on the lower part of each pixel will not adversely affect the color rendition of the image unit.

In an additional aspect of the invention, each rectangular housing includes opposed top and bottom panels that are adapted for vertical stacking. A system of male and female guide features are provided in the top and bottom panels whereby each top panel of one unit is provided with at least one male or female guide feature that interfits with a respective female or male guide feature on the bottom panel. The image units are stacked top to bottom, and the guide features assure that the stack is substantially orthogonal (or whatever other arrangement is desired). Likewise, the side panels of the housing may be provided with similar guide features, although it is not deemed essential.

The image units are arrayed in columns and rows, and the bottom row is supported on a manifold that supplies cold air or other coolant through spaced holes in the manifold. the top and bottom panels of each image unit includes at least one vent hole to promote the flow of coolant upwardly through the columns of image units. An exhaust manifold is secured to the top of the uppermost row of the array to carry away the coolant, whereby substantial heat is removed from the video array. Each image unit further includes at least one access hole in each side panel, whereby power cables and signal cables may be connected and run throughout the image units of each row in the array.

Another aspect of the invention is the threaded fastener system mentioned above. A plurality of threaded assemblies join the strongback to the LED circuit board, each having a standoff component that defines a spacing between the strongback and the LED board. The first standoff component includes a forward portion that extends through aligned mounting holes in the LED board, the gasket member, and the front panel of the housing. A second standoff component includes internal threads to engage the forward portion of the first standoff component. The second standoff component is disposed forwardly of the front panel, and joins the LED board to the rear surface of the front panel in compressive fashion with the gasket member entrained therebetween in sealing fashion.

The threaded assemblies further include a captive screw component that engages a threaded portion of the second standoff component. The captive screw components extend through similarly aligned mounting holes in the shade assembly, and may be tightened to secure the shade assembly to the forward extends of the second standoff member. This arrangement securely and rigidly supports the shade assembly on the housing, while also defining a minimum spacing between the shade assembly and the front panel of the housing. As a result, any heat buildup in the shade assembly due to solar heating thereof, or heat absorption from the LEDs themselves, cannot be conducted directly to the front panel of the housing, nor to the gasket member and LED board. Thus a major heat load factor in prior art systems is obviated.

### BRIEF DESCRIPTION OF THE DRAWINGS

FIG. 1 is a partially cutaway front perspective view of the sealed video module of the present invention.

FIG. 2 is a rear perspective view of the sealed video module shown in FIG. 1.

Figure 3 is a partial perspective view of the LED circuit board of the sealed video module of FIGS. 1 and 2.

FIG. 4 is a front plan view of the strongback component of the sealed video module of the present invention.

FIG. 5 is a rear plan view of the strongback component shown in FIG. 4.

FIG. 6 is a cross-sectional elevation of the strongback component, taken along line 6-6 of FIG. 4.

FIG. 7 is a cross-sectional elevation of the strongback component, taken along line7-7 of FIG. 4

FIG. 8 is a cross-sectional elevation of the strongback component, taken along line 8-8 of FIG. 4

FIG. 9 is a detail view of a pixel hole and the LED holes associated with it according to the present invention.

FIG. 10 is a plan view of the gasket component of the present invention.

FIG. 11 is an enlarged plan view of a portion of the gasket component shown in FIG. 10.

FIG. 12 is a cross-sectional view of the gasket component, taken along line 12-12 of FIG. 11.

FIG. 13 is a cross-sectional view of the gasket component, taken along line 13-13 of FIG. 11.

FIG. 14 is a cross-sectional view of the gasket component, taken along line 14-14 of FIG. 11.

FIG. 15 is a partial plan view of the shade component of the present invention.

FIG. 16 is an end view of the portion of the shade component shown in FIG. 15.

FIG. 17 is an exploded view of the threaded standoff assembly of the present invention.

FIG. 18 is an exploded schematic assembly of the threaded standoff assembly and the shade component, front panel, gasket, LED circuit board, strongback, and driver circuit board.

FIG. 19 is a plan view of the female guide member for interconnecting the sealed video modules of the invention.

FIG. 20 is a cross-sectional side elevation of the female guide component, taken along line 20-20 of FIG. 19.

FIG. 21 is a cross-sectional side elevation of the female guide component, taken along line 21-21 of FIG. 19.

FIG. 22 is a perspective view of the female guide component shown in FIGS. 19-21.

FIG. 23 is a plan view of the male guide component for interconnecting the sealed modules of the invention.

FIG. 24 is a cross-sectional side elevation of the male guide component, taken along line 24-24 of FIG. 23.

FIG. 25 is a cross-sectional side elevation of the male guide component, taken along line 25-25 of FIG. 23.

FIG. 26 is a perspective view of the male guide component shown in FIGS. 23-25.

### DESCRIPTION OF THE PREFERRED EMBODIMENT

The present invention generally comprises a large format video display that is highly modular in construction and adaptable to a variety of uses and installations. The modular arrangement includes a plurality of video image units, and each image unit is sealed against weather and other environmental intrusions, yet may be disassembled for repair and replacement of damaged or worn components.

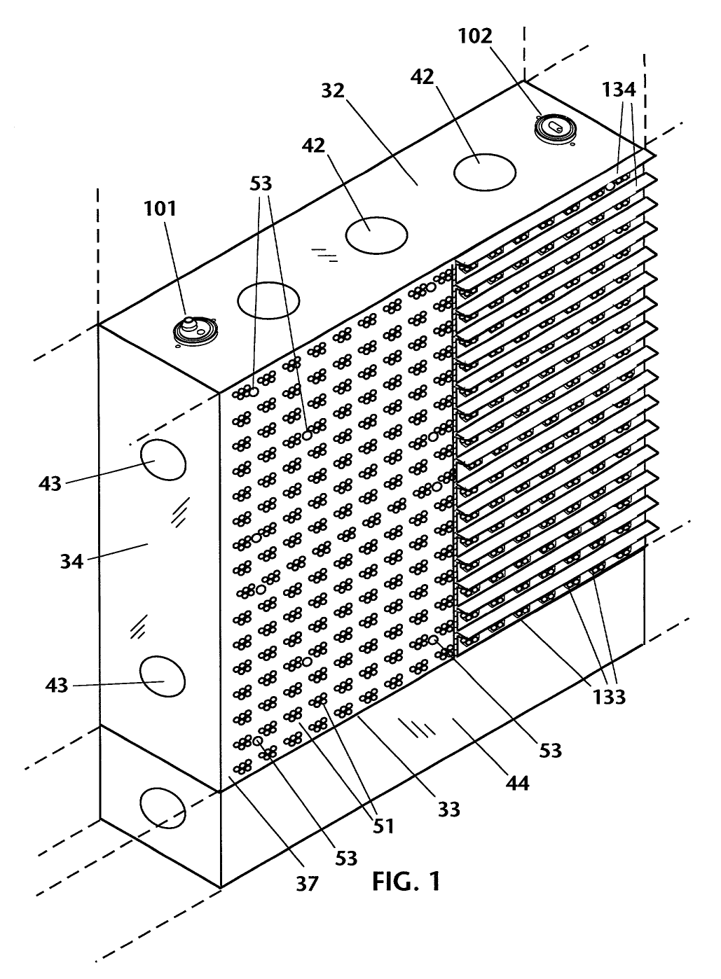

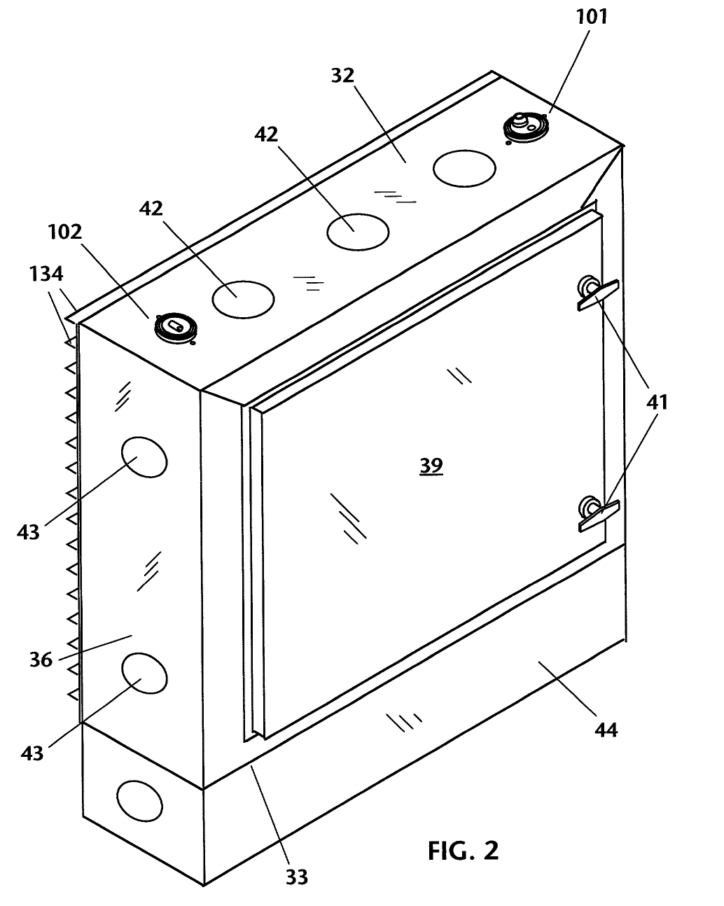

With regard to FIGS. 1 and 2, the invention provides a basic modular video output unit 31. The unit 31 includes top and bottom panels 32 and 33 and laterally opposed side panels 34 and 36 joined in a rectangular assembly, with rectangular front panel 37 spanning the panels 32-36 contiguously to form a rigid enclosure. A rear panel 38 also spans the panels 32-36, and includes a hinged door 39 that provides access to the interior of the modular unit 31. The door 39 is latched by handle assemblies 41. At least one vent hole 42 extends through the top panel 32 and bottom panel 33 (not shown) to permit air flow or coolant flow through the unit 31. In addition, at least one access hole 43 extends through the side panels 34 and 36 to accommodate power cables, signal wires, and the like to extend laterally through adjacent units 31 in a respective row of an array of the units 31. The bottom row of the array of units 31 is supported on a coolant supply manifold 44 that extends the width of the bottom row and is joined thereto to deliver cool air or other coolant to the vent holes 42 of the bottom panels of the bottom row, from which the coolant may rise through the array to remove heat therefrom. An exhaust manifold (not shown) similar to the supply manifold may be secured to the top panels of the top row of the array of units 31 to remove the heated air or coolant, or return it through a refrigeration cycle.

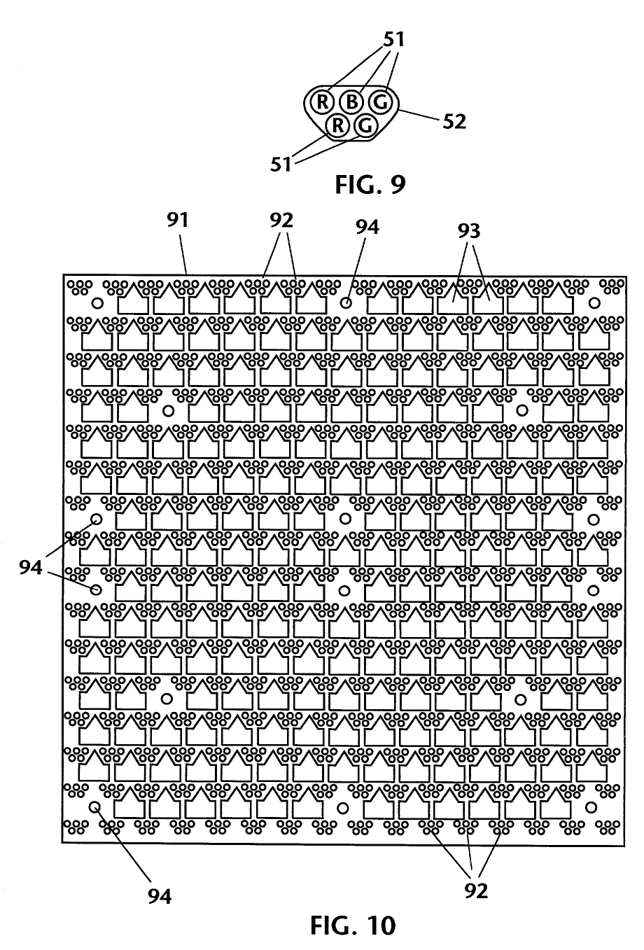

With regard to FIGS. 1 and 9, the front panel 37 of each unit 31 is provided with a plurality of LED holes 51 grouped in a pixel arrangement. Each pixel 52 includes a top row of three holes 51 and a bottom row of two holes 51, and the pixel shape is generally a regular trapezoidal having rounded vertices. The holes 51 are dimensioned to permit the output ends of LEDs to extend therethrough. In particular, the top row is provided with red, blue, and green LEDs, and the bottom row comprises red and green LEDs, for purposes to be explained in the following description. As shown in FIG. 1, the LED holes in their pixel groupings are formed a regular matrix, such as a 16×16 array (shown) or any other layout that is consonant with a video display format. The front panel also includes a plurality of mounting holes 53 in a predetermined pattern, for purposes to be explained below.

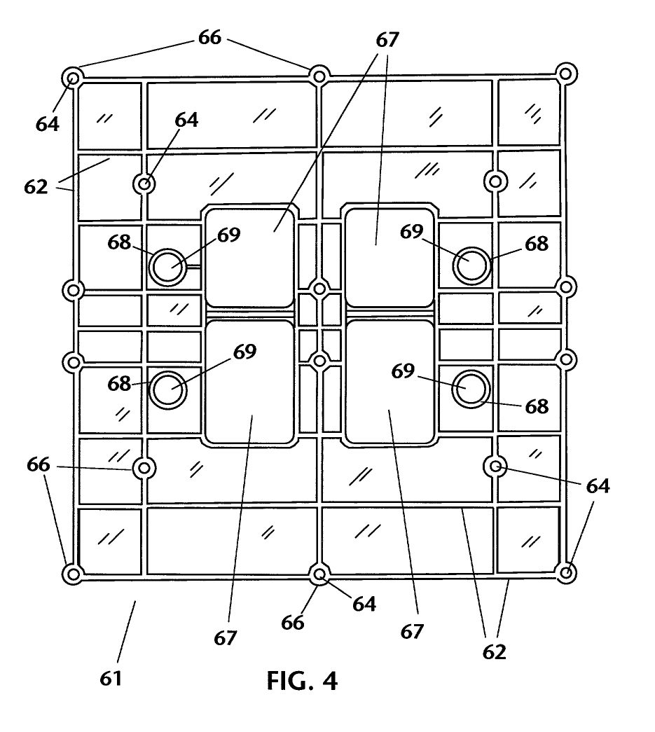

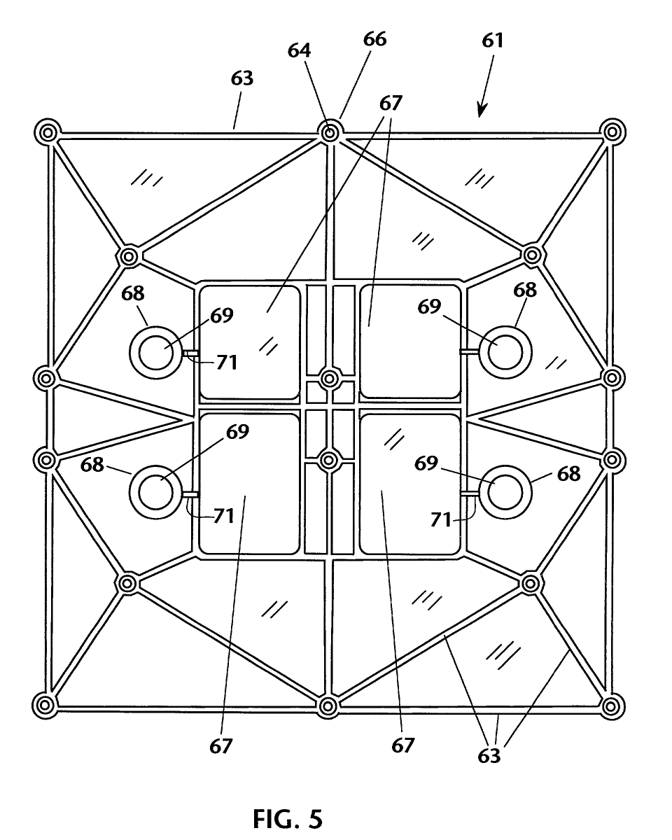

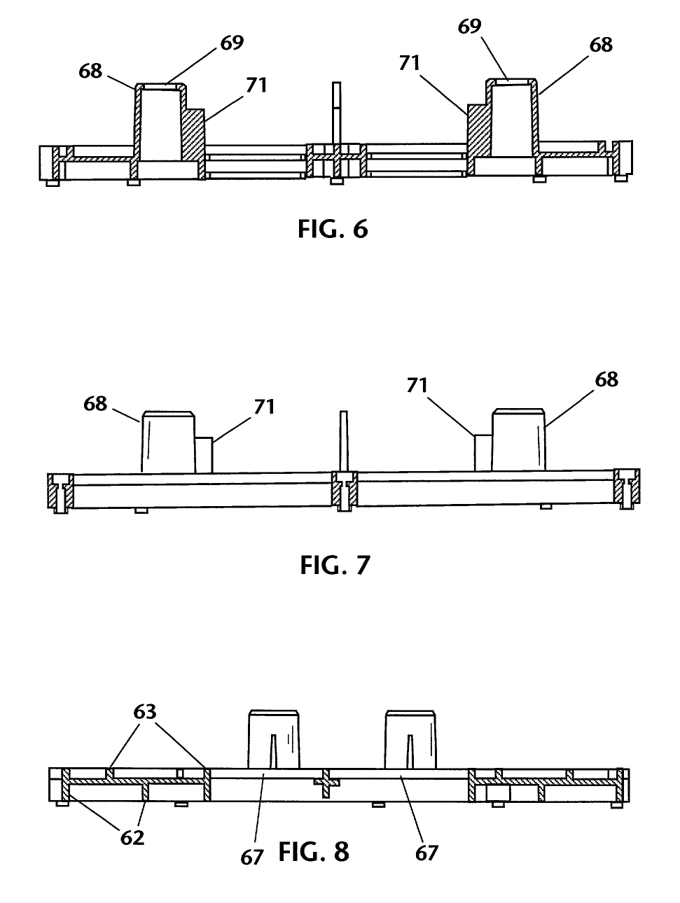

Within each unit 31, the major structural component is the strongback 61, shown in FIGS. 4-8. The strongback 61 is generally described as a fortified panel that includes a plurality of reinforcing ribs 62 disposed about the periphery and formed in a grid pattern that extends from the front face thereof, as shown in FIG. 4. Furthermore, reinforcing ribs 63 are disposed about the periphery and formed in an obtuse grid pattern extending from the rear face of the strongback 61, as shown in FIG. 5. A plurality of mounting holes 64 extend through the strongback from front to back, each mounting hole surrounded by a boss 66 that protrudes from the front and rear surfaces. The mounting holes 64 are disposed in a pattern that is identical to the pattern of the mounting holes 53 in the front panel 37 of each unit 31. Note that each boss 66 is disposed to be intersected by at least one of the reinforcing ribs 62 at the front surface, and is disposed at a converging point of two reinforcing ribs 63 at the rear surface of the strongback, so that each point of support is doubly reinforced. Furthermore, a small cylindrical protuberance 65 extends coaxially from the front end surface of each boss 66, the respective hole 64 extending through the protuberance 65, as shown in FIG. 7.

The strongback 61 also includes large rectangular cutout openings 67 extending therethrough and disposed in a rectangular grouping in the medial portion thereof. A quartet of tubular cylindrical projections 68 extend from the back surface of the strongback, arranged in two pairs of two that are disposed at laterally opposed sides of the cutout openings 67. Each projection 68 includes a coaxial hole 69 extending coaxially in the end wall thereof. A web 71 extends from the adjacent rib surface to each respective projection 68 for added rigidity and strength. The projections serve as handles for manipulating the strongback and the components assembled thereto, as explained below.

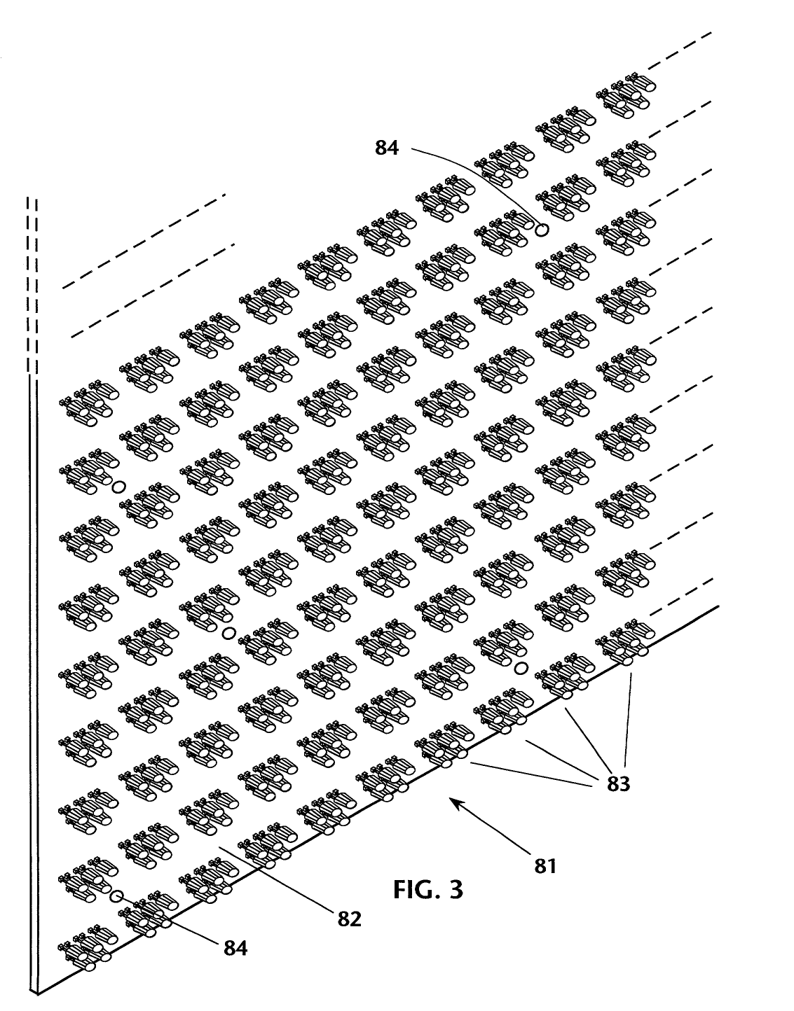

Another major component of each unit 31 is an LED circuit board 81, as shown in FIG. 3. The front surface 82 of the board 81 supports a plurality of LEDs 83, the LEDs being grouped in a pixel array in which each pixel is comprised of five LEDs, as described with reference to FIG. 9. The LEDs 83 are disposed in registration with the holes 51 in the front panel 37, and are arranged to extend through all the holes 51 when the unit is fully assembled. Each board 81 may support an array of pixel groupings, such as a 16×16 matrix, or any other usable format. The board also includes a plurality of mounting holes 84 which are arranged in a pattern identical to the mounting holes 53 of the front panel and the mounting holes 64 of the strongback. The rear surface of the board is provided with printed traces that connect and address each of the LEDs 83 individually.

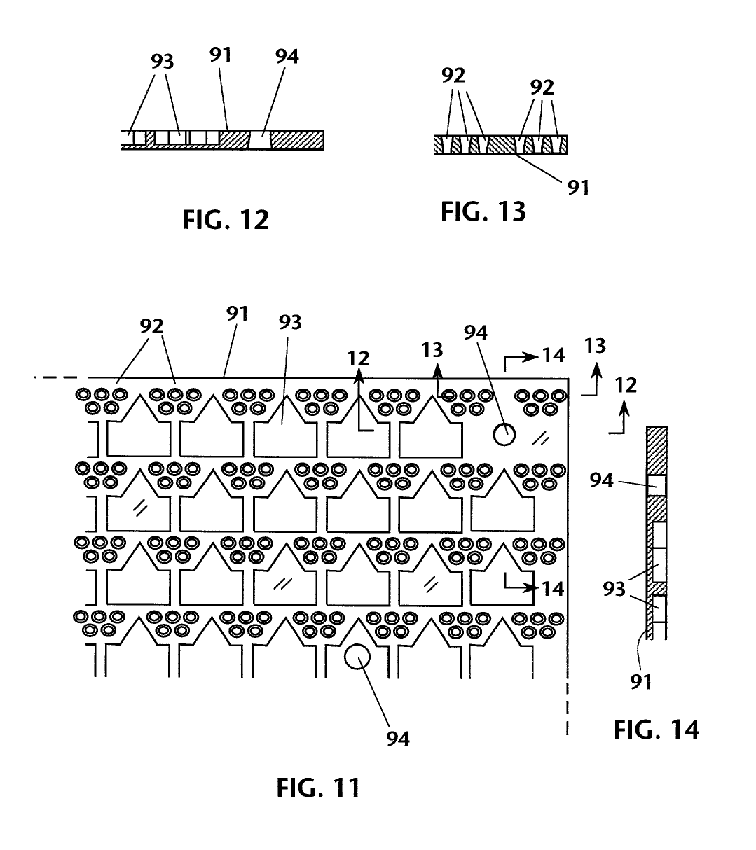

With regard to FIGS. 10-14, each unit 31 further includes a gasket component 91, comprised of a sheet of impervious, resilient material. The gasket 91 is provided with a plurality of LED holes 92, which are arranged in pixel groupings identical to those shown in FIG. 9. Between the pixel groupings, the gasket is provided with reduced thickness portions 93 which diminish the amount of material in the gasket and define seal-forming surfaces around and about all of the LED holes 92. The gasket 91 is also provided with a plurality of mounting holes 94 which are disposed in the same pattern as the mounting holes 84 of the LED board, the mounting holes 53 of the front panel, and the mounting holes 64 of the strongback.

It may be noted that the strongback 61 is secured within the unit 31, with the front surface of the strongback facing the front panel 37. The LED board 81 is assembled to the strongback in a spaced apart relationship, and the gasket 91 is assembled to the front surface of the LED board 81, with each LED 83 extending through a respective hole 92. The LEDs 83 further extend through the front panel 37, with the output end of each LED 83 extending through a respective LED hole 51 in the front panel. The gasket 91 is sandwiched between the front panel 37 and the LED board 81, and is compressed therebetween to form a weatherproof seal therewith. Thus the LED output ends protrude from the front panel to provide excellent visibility and viewing angle, while the front assembly is sealed to exclude water, moisture, insects, and other detrimental environmental factors.

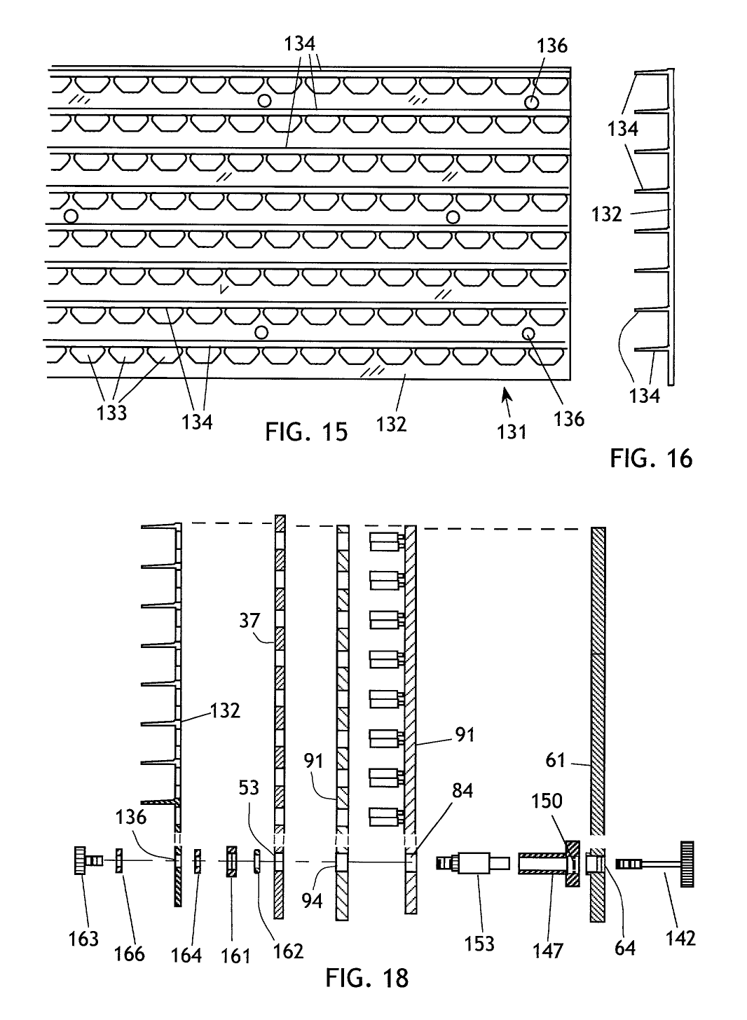

Another major component of each unit 31 is a shade assembly 131, shown in FIGS. 1, 15, and 16. The shade assembly 131 includes a flat panel 132 extending the height and width of the front panel 37, and having a plurality of pixel holes 133 formed therein in a matrix that matches the pixel layout shown in FIG. 9. The pixel holes 133 corresponds and register with the pixel grouping of the LED board, the gasket, and the front panel. That is, each pixel hole 133 in the shade panel 132 corresponds to and is aligned with a respective one of the pixel groupings 52 described previously, so that each pixel grouping of LEDs may protrude through a respective hole 133 in the shade panel. A plurality of mounting holes 136 are disposed in a pattern that is in registration with the mounting holes 53 of the front panel 37, and thus with the mounting holes of the gasket, LED circuit board, and strongback.

A salient feature of the shade assembly is a plurality of shade flanges 134 extending laterally in parallel array and projecting forwardly from the front surface of the shade panel 132. Each shade flange 134 extends approximately orthogonally from the panel 132, and is positioned directly above a row of pixel holes 133 to block at least partially the bright light emanating from the sun and sky from impinging on the protruding output ends of the LEDs. The shade panel and shade flanges may be provided with a dark absorptive coating, such a black anodized aluminum, to minimize reflection of light from bright sources, and to maximize the effect of the LEDs outputs.

With regard to FIG. 1, the shade configuration described above interacts with the pixel layout shown in FIG. 9 to preserve (to the greatest extent possible) the color rendition of the image portion projected by each unit 31. It is generally true that the strongest sunlight occurs when the sun is highest in the sky, approximated by the perspective view angle of FIG. 1. The shade flanges 134 block direct sunlight from impinging on the upper row of LEDs 51 in each pixel hole 133, so that the output of the upper row of LEDs of each pixel is not diminished by reflected sunlight (and other high angle bright light sources). Due to the fact that the blue LED is located in the upper row of each pixel, the output of each pixel grouping maintains proper color balance even during those periods when sunlight tends to attenuate the output of the lower row of LEDs of each pixel.

It is noted that the front panel, LED circuit board, gasket, and shade assembly all are provided with substantially the same rectangular configuration and dimensions, so that each unit 31 provides a complete incremental portion of a larger video image portrayed by the entire video array.

Each unit 31 further includes external features that facilitate properly aligned stacking of multiple units in true vertical relationship. With regard to FIGS. 1 and 2, the top panel 32 of each unit 31 is provided with at least one male guide 101 and/or female guide 102, and the bottom panel 33 is provided with at least one female guide 102 and/or male guide 101 positioned for complementary fit when two units 31 are aligned and stacked vertically. The complementary fit enables an installer to stack two or more units in rough vertical alignment, and the complementary interfit of the guides 101 and 102 causes the units to assume true alignment.

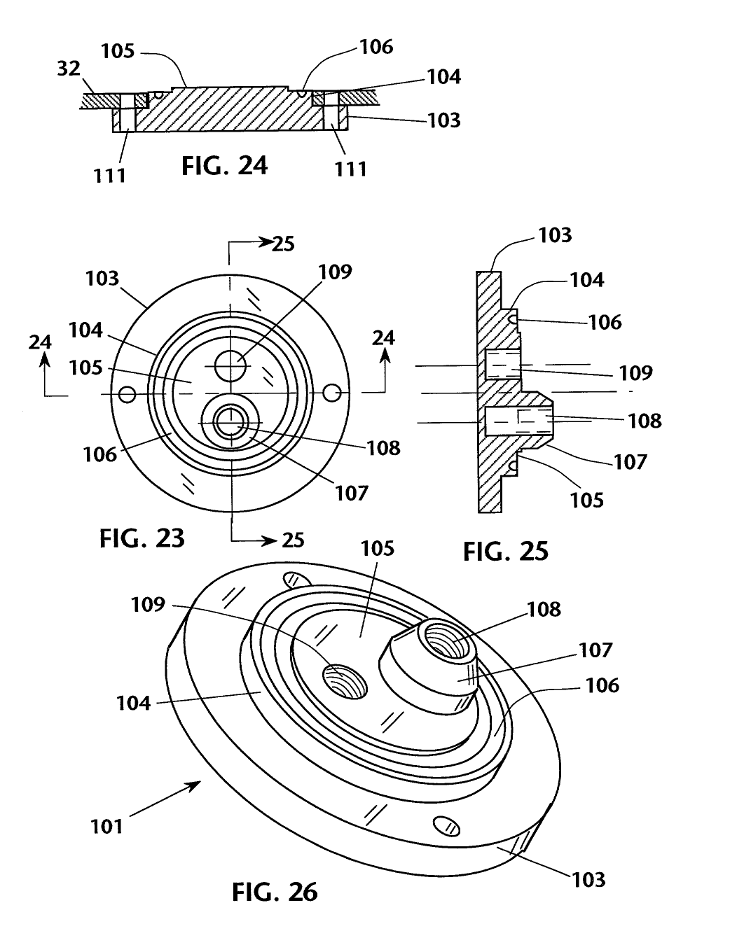

With regard to FIGS. 23-26, each male guide 101 includes a disk 103 and a central annulus 104 extending coaxially therefrom. The annulus 104 is provided in its outer face 105 with an annular groove 106 adapted to secure an O-ring gasket or the like (not shown). A tapered cylindrical lug 107 extends outwardly from the face 105, and includes a central hole 108 therein that is threaded internally. Another tapped hole 109 extends into the face 105, and does not extend through to the bottom surface of the disk 103. The lug 107 and hole 109 are diametrically opposed with respect to the central axis of the disk 103. In addition, a pair of mounting holes 111 are provided in diametrically opposed relationship in the peripheral portion of the disk 103. The holes 111 enable the guide 101 to be mounted in the top or bottom panel 32 with the face 105 thereof substantially flush with the outer surface of the panel.

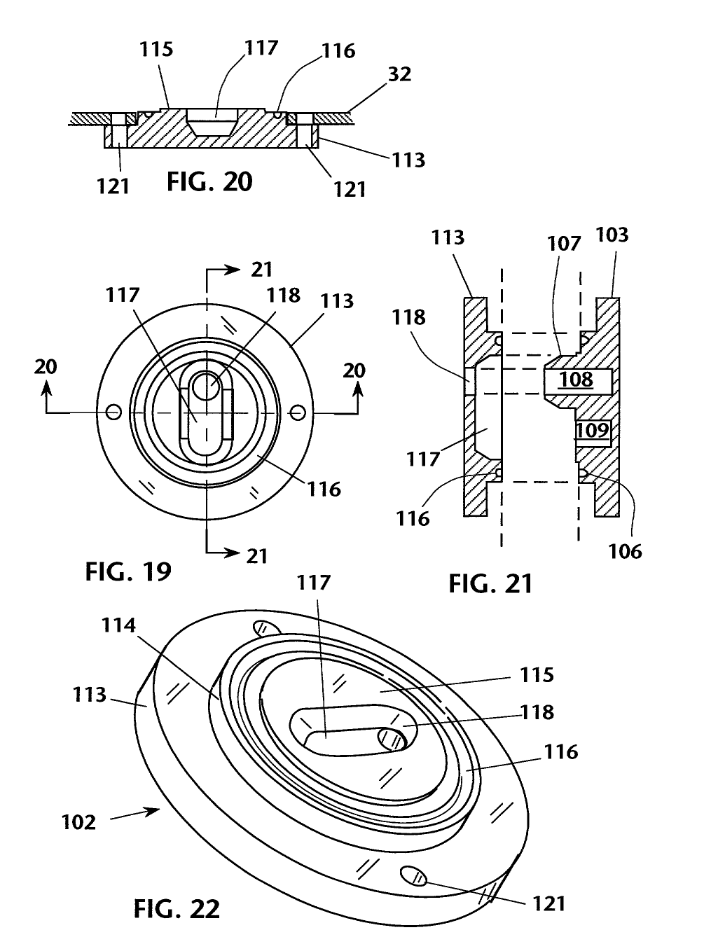

With regard to FIGS. 19-22, the female guide 102 includes a disk 113 and a central annulus 114 extending coaxially therefrom. The annulus 114 is provided in its outer face 115 with an annular groove 116 adapted to secure an O-ring gasket or the like (not shown). A tapered channel 117 extends inwardly and diametrically in the face 115, and includes a hole 118 at one end of the channel that extends through to the bottom face of the disk. In addition, a pair of mounting holes 121 are provided in diametrically opposed relationship in the peripheral portion of the disk 113. The holes 121 enable the guide 101 to be mounted in the top or bottom panel of the unit 31 with the face 115 thereof substantially flush with the outer surface of the panel.

With particular reference to FIG. 21, the tapered cylindrical lug 107 of the male guide 101 is dimensioned to be received in the channel 117 with minimal clearance, so that the two guides are drawn into alignment by engagement. The tapped holes 108 and 109 are positioned so that one of them is in alignment with the hole 118 through the female guide 102. That is, no matter which end of the channel 117 receives the lug 107, there is hole alignment so that a screw or bolt may be extended through the hole 118 to secure the male guide 101 thereto. Thus the male/female guide engagement assures alignment of the units 31 to which they are joined, and they also provide a means to fasten the units together to form a large video array. Also note that the O-ring seal retained in grooves 106 and 116 eliminate any intrusion of environmental factors into the array through the guide assemblies.

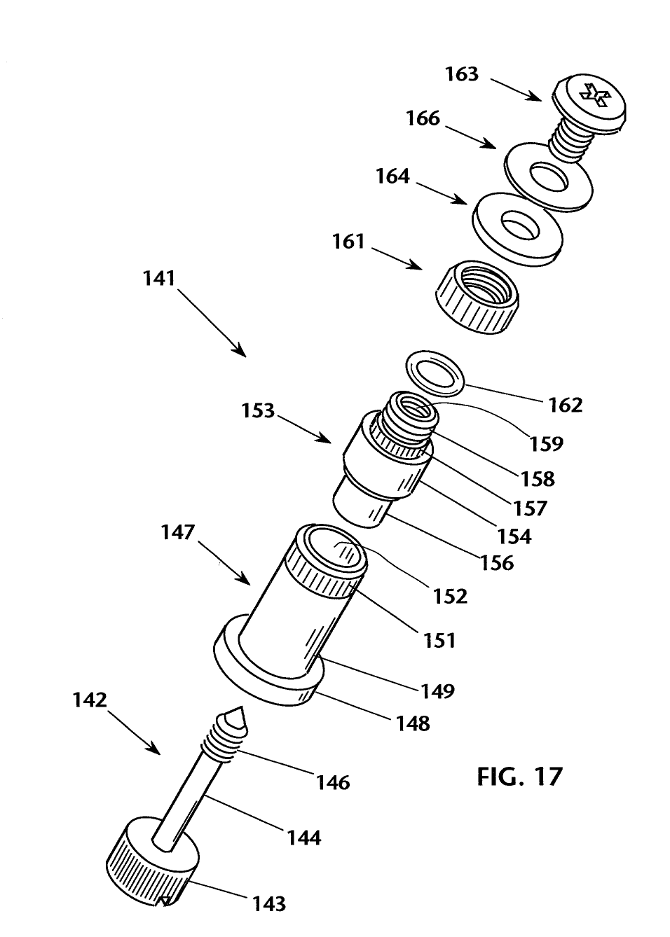

With regard to FIG. 17, the invention includes a plurality of threaded assemblies 141 that join the strongback, LED circuit board, and gasket to the front panel within each unit 31, and that secures the shade assembly to the exterior of the front panel of the unit 31. The assembly 141 includes a captive screw 142, comprised of a knurled head 143, a shank 144, and a threaded distal end 146 that is greater in diameter than the shank. The shank and tapped portion 146 extend through a captive screw standoff component 147. The standoff 147 includes a head 148 having a tapped hole 150 extending axially therethrough to join a bore 152 that extends axially through the tubular body portion 149. The distal end portion 151 of the body 149 is knurled. Note that the tapped portion 146 of the screw 147 may be threaded through the tapped hole 150, whereafter the shank 144 may translate freely through the hole 150. Thus the screw 142 is held captive in the standoff 147.

The assembly 141 also includes a swage standoff (spacer) component 153, which includes a tubular body portion 154. A tubular neck 156 extends from the proximal end of body 154, and is dimensioned to be received in the bore 152 with minimal clearance. A knurled portion 157 extends from the distal end of body 154, and a threaded distal end 158 extends from portion 157. A bore 159 extends axially through the standoff 153, and is threaded through to receive the tapped end 146 of the screw 142. An internally threaded collar 161 is dimensioned to be screwed onto the threaded end 158, and an annular seal ring 162 is captured compressively between the collar 161 and the knurled portion 157. A screw 163 extends through the open end of the collar 161, and is threaded to be secured within the threaded bore 159. A pair of washers 164 and 166 are secured on the screw 16 between the screw head and the collar 161.

With regard to FIG. 18, each threaded assembly 141 is adapted to join the join the strongback 61, LED circuit board 91, and gasket 91 to the front panel 37 within each unit 31, and secure the shade assembly 131 to the exterior of the front panel of each unit 31. The captive screw 142 is threaded through the shallow threads of hole 64 of strongback 61, and thence through the shallow threaded portion 150 of standoff 147, whereafter the shank of screw 142 is free to translate through the standoff 147 to engage the internal threaded bore 159 of standoff 153. The standoff 147 establishes a uniform spacing between the strongback and the LED circuit board. The distal end portion 158 of standoff 153 extends through mounting hole 84 of LED board 91, through mounting hole 94 of gasket 91, and through mounting hole 53 of front panel 37. The threaded collar 161 is threaded onto portion 158 and tightened to compress the gasket 91 between the LED board and the front panel, thereby forming a weatherproof seal therewith. Note that the compressive force is applied at each of the mounting holes, which are spaced throughout the board assembly to avoid stress concentrations in the LED board.

The shade assembly 132 is secured to the outer surface of the front panel 37 by screw 163, which extends through washer 166 and through mounting hole 136 of the shade panel. The screw 163 also extends through washer 164 and through the open end of threaded collar 161, and is threaded into the bore 159 of the standoff 153. The threaded collar 161 serves as a spacer to separate the shade assembly from the front panel, so that heat generated by the shade assembly (e.g., due to solar heating on sunny days) is not conducted directly to the front panel nor to the LED circuit board 91.

It may be appreciated that the strongback, LED board and gasket may be introduced into each unit 31 through the door 39, with the screws 142 captive in the strongback/standoff assemblies. The threaded collars 161 are assembled to the standoff assemblies at the outer surface of the front panel to form the compressive seal with the gasket, and the shade assembly is then secured at the outer surface of the front panel. The components are easily dismantled for repair and replacement purposes. These tasks may be performed before the units 31 are assembled in a video array, or may be carried out for maintenance and repair after the array is constructed.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A large format video display comprised of a plurality of modular units assembly in an array, each modular unit including:
a housing having a front panel;
an LED circuit board supporting a plurality of LEDs extending therefrom in a forward direction, said LEDs being arranged in an array of pixels in a matrix;
said front panel having a plurality of panel holes extending therethrough, said LEDs extending through said panel holes;
a gasket interposed between said front panel and said LED circuit board, said gasket having a plurality of gasket holes extending therethrough, said LEDs extending through said gasket holes; and,
means for compressively joining said LED circuit board to said front panel with said gasket sandwiched therebetween to form a sealed assembly.

2. The video display assembly of claim 1, wherein each of said panel holes is dimensioned and disposed to receive therethrough a respective one of said LEDs from said LED circuit board.

3. The video display assembly of claim 1, wherein said LEDs are arranged in pixel groupings, each pixel grouping including LEDs of differing colors.

4. The video display assembly of claim 1, wherein each of said gasket holes are dimensioned and disposed to receive therethrough a respective one of said LEDs from said LED circuit board.

5. The video display assembly of claim 1, wherein said means for compressively joining includes a first plurality of mounting holes extending through said front panel, a second plurality of mounting holes extending through said LED circuit board, said first and second plurality of mounting holes arranged in an identical layout pattern, each of said first plurality of mounting holes disposed in alignment with a respective one of said second plurality of mounting holes.

6. The video display assembly of claim 5, further including fastener means extending through each of said first mounting holes and the respectively aligned second mounting hole.

7. The video display assembly of claim 6, further including a third plurality of mounting holes extending through said gasket and arranged in said identical layout pattern, said fastener means extending through said third plurality of mounting holes.

8. The video display assembly of claim 3, further including a sunshade secured to an exterior surface of said front panel.

9. The video display assembly of claim 8, wherein said sunshade includes a plurality of pixel holes arranged in said matrix, each pixel hole aligned with one of said pixel groupings of LEDs, each pixel grouping of LEDs projecting light output through a respective one of said pixel holes.

10. The video display assembly of claim 9, wherein said sunshade further includes a plurality of shade flanges extending in a lateral direction and projecting forwardly, each of said shade flanges disposed directly superjacent to a row of said matrix of pixels.

11. The video display assembly of claim 10, wherein each of said pixel groupings of LEDs includes a top row and a bottom row of LEDs, and said top row includes a blue LED.

12. The video display assembly of claim 11, wherein said top row further includes a red and a green LED, and said bottom row includes a red and a green LED.

13. The video display assembly of claim 11, wherein said shade flanges extend forwardly a sufficient distance to substantially shade said top row of LEDs and prevent diminution of the output of said blue LED.

14. The video display assembly of claim 10, wherein said sunshade includes a shade panel for supporting said shade flanges, said shade panel extending generally parallel to said front panel.

15. The video display assembly of claim 14, wherein said means for compressively joining includes a first plurality of mounting holes extending through said front panel, and said shade panel includes a fourth plurality of mounting holes extending therethrough, said first and fourth plurality of mounting holes arranged in an identical layout pattern, each of said first plurality of mounting holes disposed in alignment with a respective one of said fourth plurality of mounting holes.

16. The video display assembly of claim 15, further including fastener means extending through each of said first mounting holes and the respectively aligned fourth mounting hole.

17. The video display assembly of claim 16, further including spacing means for securing said sunshade in spaced apart relationship to said front panel.

18. The video display assembly of claim 17, wherein said spacing means includes a spacer in said fastener means.

19. The video display assembly of claim 7, wherein said means for compressively joining includes a strongback panel for supporting said LED circuit board, said fastener means joining said strongback to said front panel with said LED circuit board and said gasket disposed therebetween.

20. The video display assembly of claim 19, wherein said strongback includes a fifth plurality of mounting holes extending therethrough and arranged in said identical layout pattern, said fastener means extending through said fifth plurality of mounting holes.

21. The video display assembly of claim 21, wherein said fastener means includes a plurality of fastener assemblies, each fastener assembly extending through respective aligned holes of said first, second, third, and fifth pluralities of mounting holes.

22. The video display assembly of claim 21, wherein each fastener assembly includes a first standoff disposed between said strongback and said LED circuit board to define a spacing between said strongback and said LED circuit board.

23. The video display assembly of claim 22, wherein each fastener assembly further includes a captive screw extending through one of said fifth mounting holes of said strongback, thence through said standoff.

24. The video display assembly of claim 23, wherein each fastener assembly further includes a generally tubular spacer member, said spacer member including a bore tapped to engage said captive screw.

25. The video display assembly of claim 24, wherein each spacer member includes a tubular portion dimensioned to extend through respectively aligned first, second, and third mounting holes.

26. The video display assembly of claim 25, wherein said tubular portion of each spacer member is externally threaded, and each fastener assembly includes a threaded collar adapted to retain the threads of said tubular portion, said collar being secured at the outer surface of said front panel.

27. The video display assembly of claim 25, further including a sunshade disposed adjacent to said outer surface of said front panel, said sunshade including a fourth plurality of mounting holes extending therethrough and arranged in said identical layout pattern.

28. The video display assembly of claim 27, wherein each fastener assembly includes a screw extending through a respective fourth mounting hole and through said collar and secured in said tapped bore of said standoff.

29. The video display assembly of claim 1, further including guide means for aligning a plurality of said modular units in vertically stacked relationship.

30. The video display assembly of claim 29, wherein said housing includes top and bottom panels in vertically spaced, generally parallel disposition, and said guide means includes a plurality of pairs of guide assemblies, one of each pair of guide assemblies being secured to said top panel of each housing and the other of each pair of guide assemblies being secured to said bottom panel of each housing, each pair of guide assemblies being vertically aligned between vertically adjacent modular units in said video display array.

31. The video display assembly of claim 30, wherein said one guide assembly includes a tapered tubular protuberance extending therefrom.

32. The video display assembly of claim 31, wherein said other guide assembly includes a channel formed therein, said channel being dimensioned to receive said protuberance of said one guide assembly with minimal clearance.

33. The video display assembly of claim 32, wherein said protuberance includes a first threaded bore extending axially therein.

34. The video display assembly of claim 33, wherein said channel includes a hole extending therein, said hole being alignable with said first threaded bore of said protuberance to introduce a threaded fastener into said first threaded bore.

35. The video display assembly of claim 34, wherein said one guide member includes a second threaded bore extending parallel to said first threaded bore and spaced apart from said protuberance.

36. The video display assembly of claim 35, wherein said hole in said channel is alignable with either said first or second threaded bore to introduce said threaded fastener into either said first or second threaded bore.

37. A large format video display comprised of a plurality of modular units assembly in an array, each modular unit including:
a housing having top and bottom panels in vertically spaced, generally parallel disposition;
guide means for aligning a plurality of said modular units in vertically stacked relationship, said guide means includes a plurality of pairs of guide assemblies, one of each pair of guide assemblies being secured to said top panel of each housing and the other of each pair of guide assemblies being secured to said bottom panel of each housing, each pair of guide assemblies being vertically aligned between vertically adjacent modular units in said video display array.

38. The video display assembly of claim 37, wherein said one guide assembly includes a tapered tubular protuberance extending therefrom.

39. The video display assembly of claim 38, wherein said other guide assembly includes a channel formed therein, said channel being dimensioned to receive said protuberance of said one guide assembly with minimal clearance.

40. The video display assembly of claim 39, wherein said protuberance includes a first threaded bore extending axially therein.

41. The video display assembly of claim 40, wherein said channel includes a hole extending therein, said hole being alignable with said first threaded bore of said protuberance to introduce a threaded fastener into said first threaded bore.

42. The video display assembly of claim 41, wherein said one guide member includes a second threaded bore extending parallel to said first threaded bore and spaced apart from said protuberance.

43. The video display assembly of claim 42, wherein said hole in said channel is alignable with either said first or second threaded bore to introduce said threaded fastener into either said first or second threaded bore.
